(19) United States
(12) Patent Application Publication
(10) Pub. No.: US 2003/0234862 A1
(43) Pub. Date: Dec. 25, 2003

(54) Aircraft mounted video recording system

(76) Inventor: Dan Keith Andersen, Alberta (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/176,170

(22) Filed: Jun. 19, 2002

(51) Int. Cl. H04N 7/18

(52) U.S. Cl. 348/144

(57) ABSTRACT

An aircraft mounted video recording system includes, in combination, an aircraft and at least one video camera secured to the aircraft. A solid state storage unit is provided having a storage capacity of at least 5 gigabytes of uncompressed data. The solid state storage unit is mounted within the aircraft and receives data from the at least one video camera.

### FIELD OF THE INVENTION

The present invention relates to an aircraft mounted video recording system.

### BACKGROUND OF THE INVENTION

Aircraft mounted video recording systems are used for a wide variety of applications. They are used by military, police and news organizations for aerial surveillance. They are used by the film industry in the making of films. They are used by the petroleum and mining industries for aerial surveying and inspection. They are used by environmental and conservation agencies for monitoring wildlife populations. In view of the unfortunate events relating to the September 11th, attack on the World Trade Center, there will increasingly be on board cameras monitoring the activities of passengers on passenger aircraft.

At the present time, the weak link in such aircraft mounted video recording systems is the storage medium. Video recorders are currently viewed as being the best available technology to record video output. In some applications, video output is communicated through wireless communication or via satellite to a computer positioned at a remote ground station. Generally, computers are not positioned on board aircraft to store video output. The reason for this is that the computers which are commonly used in our homes and businesses are too sensitive to the gravitational forces and vibration acting upon the aircraft. In some applications, such as flying at over a hundred miles per hour aerial mapping with infrared cameras looking for defects in pipelines, a further problem encountered is that the data stream is too fast and there is too much data for a computer to handle the data. In other applications problems are encountered due to the fact that computers are relatively temperature sensitive and will not operate properly in environments which are either too hot or too cold. A final problem, is the size and power requirements of computers that might be capable of handling the speed and volume of data, assuming that such computers could be isolated from gravitational forces and vibration.

### SUMMARY OF THE INVENTION

What is required is a more reliable aircraft mounted video recording system.

According to the present invention there is provided an aircraft mounted video recording system which includes, in combination, an aircraft and at least one video camera secured to the aircraft. A solid state storage unit is provided having a storage capacity of at least 5 gigabytes of uncompressed data. The solid state storage unit is mounted within the aircraft and receives data from the at least one video camera.

The aircraft mounted video recording system, as described above, represents an advance in the art. It s solid state storage units are not sensitive to gravitational forces or vibration. It operates through a relatively wide temperature range, as compared to computers we currently use for our homes and our businesses. It accepts a faster data stream. A trade off must be made between weight and storage capacity. A storage capacity of at least 5 gigabytes of uncompressed data is viewed as being necessary for this application. It is recognized that as data compression techniques improve that 5 gigabytes of uncompressed data may be stored in a compressed format.

Although beneficial results may be obtained through the use of the system, as described above, even more beneficial results may be obtained when a dedicated power supply is provided, separate and distinct from the electrical system of the aircraft, for supplying power to the solid state storage unit. The dedicated power supply is provided so as not to interfere with the electrical system of the aircraft.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a top plan view, in section, of an aircraft mounted video recording system constructed in accordance with the teachings of the present invention.

FIG. 2 is a schematic view of the aircraft mounted video recording system illustrated in FIG. 1.

FIG. 3 is a schematic view of the aircraft mounted video recording system with a security camera mounted inside a passenger compartment.

### DETAILED DESCRIPTION OF THE PREFERRED EMBODIMENT

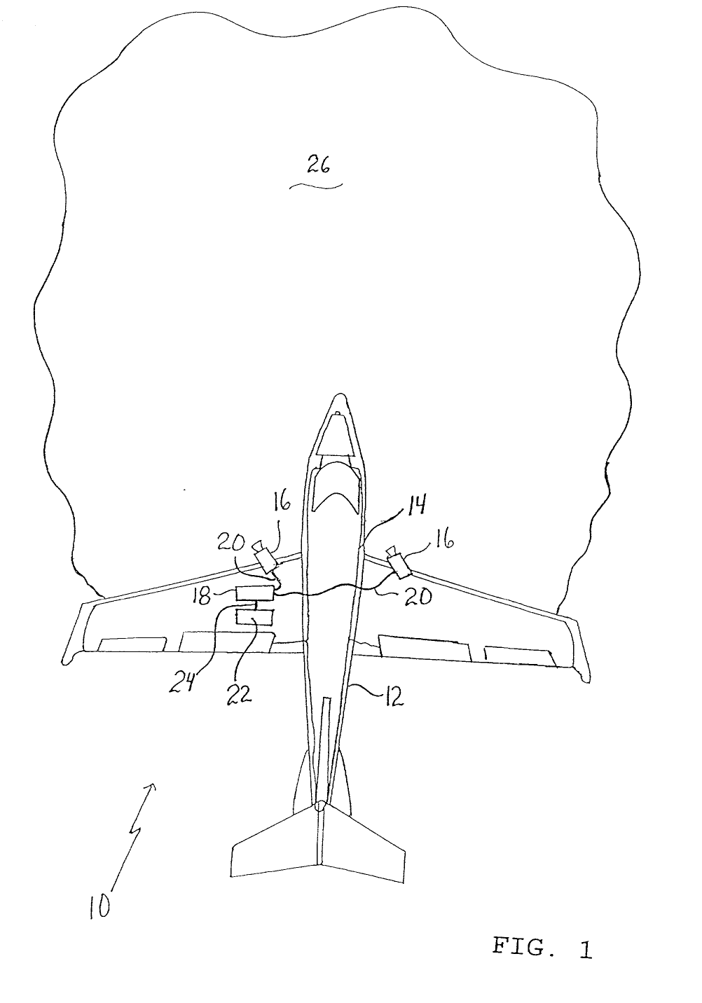

The preferred embodiment, an aircraft mounted video recording system generally identified by reference numeral 10, will now be described with reference to FIGS. 1 through 3.

Structure and Relationship of Parts:

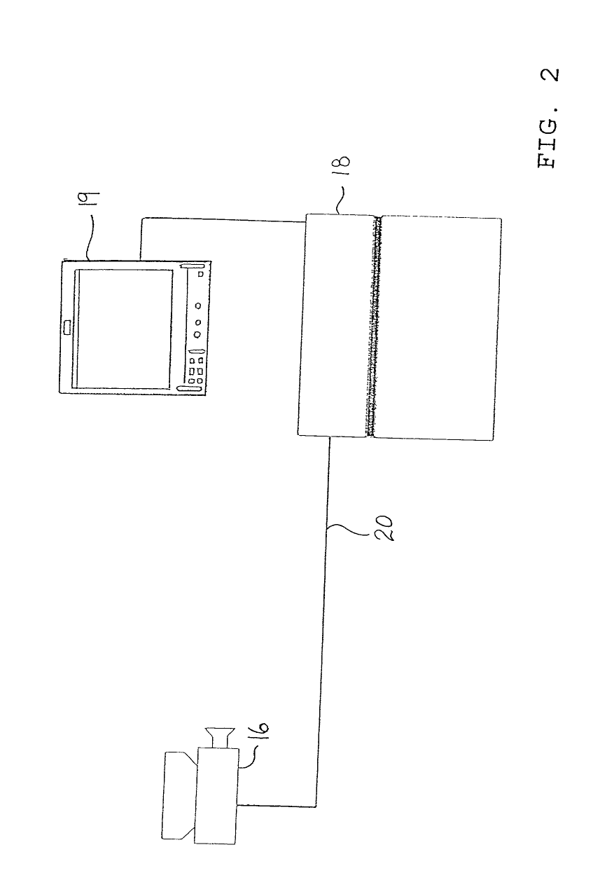

Aircraft mounted video recording system 10 includes an aircraft 12 having an electrical system, which is represented by wires 14. Video cameras 16 are secured to aircraft 12. Video cameras 16 are shown as being mounted externally, as would be the case with an aerial mapping or surveillance application. It will be appreciated that video cameras 16 could be mounted within aircraft 12 to monitor passengers or cargo, as will hereinafter be further described. A solid state storage unit 18 is provided. Solid state storage unit 18 has a storage capacity of at least 5 gigabytes of uncompressed data for this application, in view of the quantity and speed of the data stream. It is preferred that the storage capacity be over 30 gigabytes of uncompressed data. The storage capacity is expressed in terms of uncompressed data. It is will be appreciated that the equivalent amount of data could be stored using data compression. Solid state storage unit 18 is mounted within aircraft 12 and receives data from video cameras 16 via input cables 20. A dedicated power supply 22 is provided. Power supply 22 is separate and distinct from electrical system 14 of aircraft 12. Power supply 22 supplies power via power cable 24 to solid state storage unit 18. Referring to FIG. 2, it is preferred that a display monitor 19 be provided to enable members of the flight crew to monitor the images being captured.

Operation:

The use and operation of aircraft mounted video recording system 10 will now be described with reference to FIGS. 1 through 3. Referring to FIG. 1, aircraft 12 flies over a ground area 26. Video cameras 16 take video images of ground area 26. The video images are communicated via input cables 20 to solid state storage unit 18. The power that solid state storage unit 18 requires to operate is supplied by power supply 22 via power cable 24. Referring to FIG. 2, members of flight crew can monitor the images being captured.

Variations:

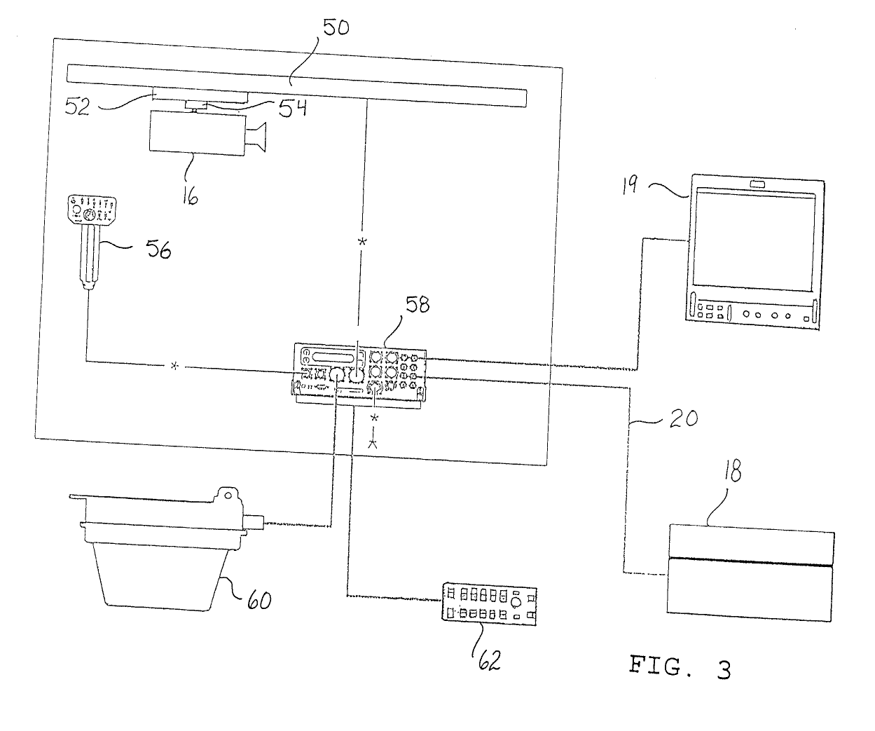

Referring to FIG. 3, as an anti-terrorist measure it may be desirable to position camera 16 within the passenger compartment of the aircraft. Camera 16 is mounted on tracks 50. It is moved by a drive motor 52 along tracks 50. A further drive motor 54 is provided to facilitate angular positioning of camera 16. A hand controller 56 is provided to enable members of the flight crew to activate drive motor 52 to move camera 16 along tracks 50 and to activate drive motor 54 to angularly position camera 16 up or down and side to side. The focus functions of camera 16 are also controlled through hand controller 56. As before, solid state storage unit 18 is provided which receives data from video cameras 16 via input cables 20 and a display monitor 19 is provided to enable members of the flight crew to monitor the images being captured. It is envisaged that an on board interface unit 58 will be provided through which the various components of the system are controlled. In addition, all data can be sent to ground based security personnel via a microwave transmitter 60. In the event of an incident on the aircraft, a ground based control panel 62 can take over operation of the various components of the system, such as control over the positioning of camera 16 via duplicate over-riding controls.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The embodiments of the invention in which an exclusive property or privilege is claimed are defined as follows:

1. An aircraft mounted video recording system, comprising in combination:
an aircraft;
at least one video camera secured to the aircraft; and
a solid state storage unit having a storage capacity of one of at least 5 gigabytes of uncompressed data or its compressed data equivalent mounted within the aircraft and receiving data from the at least one video camera.

2. The aircraft mounted video recording system as defined in claim 1, wherein a dedicated power supply, separate and distinct from an electrical system of the aircraft, supplies power to the solid state storage unit.

3. The aircraft mounted video recording system as defined in claim 1, wherein the at least one video camera is positioned to capture images below the aircraft.

4. The aircraft mounted video recording system as defined in claim 1, wherein the at least one video camera is positioned to captures images within the aircraft.

5. The aircraft mounted video recording system as defined in claim 4, wherein the at least one video camera is mounted on a track, a motor being provided to move the at least one video camera along the track.

6. The aircraft mounted video recording system as defined in claim 1, wherein a display monitor is provided to enable members of a flight crew for the aircraft to monitor images being take by the at least one video camera.

7. The aircraft mounted video recording system as defined in claim 5, wherein a controller is provided in order to enable members of a flight crew of the aircraft to selectively activate the motor in order to control positioning of the at least one video camera along the track.

8. The aircraft mounted video recording system as defined in claim 4, wherein the images taken by the at least one video camera are transmitted to ground based monitoring stations.

9. The aircraft mounted video recording system as defined in claim 5, wherein a controller is provided at a ground based monitoring station in order to enable security personnel at the ground based monitoring station to selectively activate the motor in order to control positioning of the at least one video camera along the track.
